(19) United States
(12) Patent Application Publication
(10) Pub. No.: US 2006/0206346 A1
(43) Pub. Date: Sep. 14, 2006

(54) Activity forms for automated business processes

(76) Inventors: Arthur Grand, Roseville, CA (US); David Glende, Roseville, CA (US)

Correspondence Address: SCHNECK & SCHNECK, P.O. BOX 2-E, SAN JOSE, CA, 95109-0005, US

(21) Appl. No.: 11/075,110

(22) Filed: Mar. 8, 2005

(51) Int. Cl. G06Q 99/00; G06F 17/30; G06F 17/00

(52) U.S. Cl. 705/1; 715/506; 707/1

(57) ABSTRACT

A method and computer-readable storage medium for performing the method of creating a business process workflow user interface (“activity form”) featuring process data and process-related data where no manual coding is required to integrate different data sources into the user interface. An activity form associated with an activity from a business process workflow is created with at least one field associated with an operand of the related process definition. A relationship is specified with at least one operand and at least one process-related data source.

### TECHNICAL FIELD

This invention relates to creating online forms, particularly online forms for activities in business processes which incorporate different data sources.

### BACKGROUND OF THE INVENTION

The automation of business processes has become increasingly popular. In order to automate business processes, a computer representation of the process workflow, which breaks the process into component activities, is created. Users accessing the automated business process interact with the computer representation of the workflow, for instance via web pages.

Often, these web pages need to display information from different data sources, such as relational databases, web services, enterprise applications, a legacy mainframe/AS 400 application, etc. For instance, in an automated process for managing a call center, a customer service representative needs to examine each call and decide whether the call can be marked as “closed” (in other words, the customer's concerns have been addressed). To do this, the customer service representative would access a web page containing the ticket number assigned to the particular call together with detail records indicating the information exchanged between the customer and the customer service representative during the call. Usually, the ticket number is stored as part of a process definition and the detail records, or process-related data, are stored in a relational database. (Other detail records may be stored in other data sources, such as web services, enterprise applications, etc.) The process definition and detail records are obtained from two different data sources which must be integrated on the form.

Integrating different data sources can be very expensive and time-consuming. One approach to integrating different data sources is to map the required data source to a generic data structure (for instance, using XML) and then mapping the generic data structure to the format required by the service package. These integration steps must be performed for each data source. Custom-programmed connectors from one data source to the service package may also be used. Both of these approaches require significant special coding on the part of programmers before a data source may be integrated into a business process form.

It would be useful to create business process workflow user interfaces, or activity forms, to automate activities within a business process. It would also be useful if different types of data, such as process data and process-related data, could be presented in the form without requiring manual coding on the part of programmers to integrate the different data sources.

### SUMMARY OF THE INVENTION

These goals have been met by a method and software for performing the method of creating a business process workflow user interface, or activity form, featuring process data and process-related data. In one embodiment, the method comprises: identifying an activity within a process requiring a form; creating an activity form with at least one field associated with an operand representing process data; modifying the activity form by adding at least one field from the process-related data source to the activity form; and specifying a relationship between the at least one operand and at least one process-related data source.

In another embodiment, a method for automating at least part of a business process by using a business form comprises: identifying an activity within a business process flow where a form may be used; creating an activity form having at least one field associated with an operand representing process data and at least one field of process-related data, wherein a relationship between the operand and a source of the process-related data is indicated during creation of the activity form, and a button indicating a decision to be made by an end user of the activity form; presenting the activity form to an end user when requested by the end user; and saving any changes made by the end user to any data in the activity form.

### BRIEF DESCRIPTION OF THE DRAWINGS

FIG. 1 is a flowchart showing the steps in an exemplary process of fulfilling an order.

FIG. 2 is a block diagram of the types of data which may be included in an activity form in accordance with the invention.

FIG. 3a is a block diagram of an exemplary configuration of a network in which the invention is deployed.

FIG. 3b is a block diagram of another exemplary configuration of a network in which the invention is deployed.

FIG. 4 is a block diagram of exemplary components of the invention.

FIG. 5 is a flowchart of the creation of a business process flow in accordance with the invention.

FIG. 6 is a flowchart of the creation of an activity form in accordance with the invention.

FIG. 7 is an exemplary activity form created in accordance with the invention.

FIG. 8 is a flowchart of the implementation of a business process using activity forms in accordance with the invention.

### DETAILED DESCRIPTION

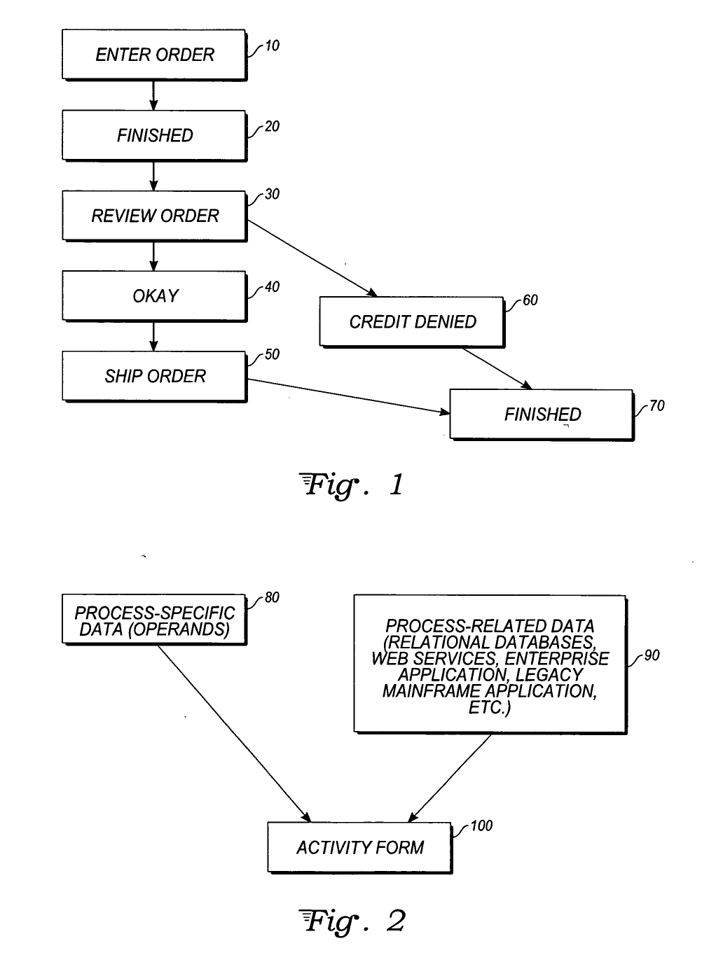

A business process may consist of separate activities which must be performed in order to complete the process. With reference to FIG. 1, a business process for fulfilling an order from a customer begins with entering the customer's order (block 10). Once this activity is finished (block 20), the order must be reviewed to determine whether the order can be filled (block 30). If the order cannot be filled, for instance because credit cannot be extended to the customer (block 60), the process is stopped (block 70). However, if review of the order (block 30) indicates that the order can be filled (block 40), the order is shipped (block 50), after which the process is finished (block 70). Activities in this business process include entering the order, reviewing the order, and shipping the order.

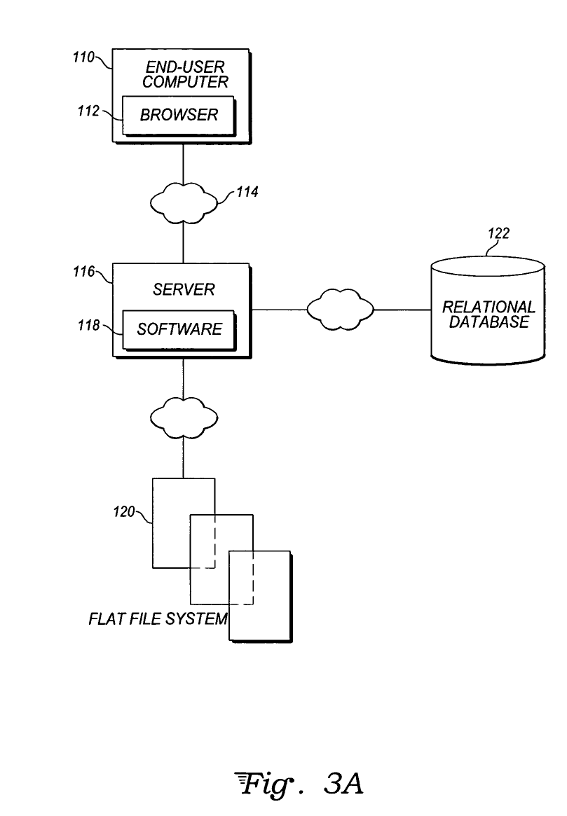

One approach to automating a business process is to break the process into its component activities as demonstrated above and then automating each of these activities as required. It may be necessary to use several different sources of data when automating activities. If an electronic form is used to automate an activity, the form should include process-specific, or process, data, for instance a ticket number, as well as process-related data, such as information about the customer associated with the ticket number, information about service calls to the customer, etc. While the process data may be generated by the automating application, the process-related data may come from different relational and non-relational sources and may, in some instances, pre-date the process data. Relational sources include, but are not limited to, relational databases. Non-relational sources include, but are not limited to, web services, enterprise applications (such as SAP and Peoplesoft), a legacy mainframe/AS400 application, or “flat files,” such as spreadsheets or word processing documents. Referring to FIG. 2, an activity form 100 (i.e., a form associated with a particular activity that is automated) should include process data or elements (operands) 80 as well as process-related data 90 as discussed above.

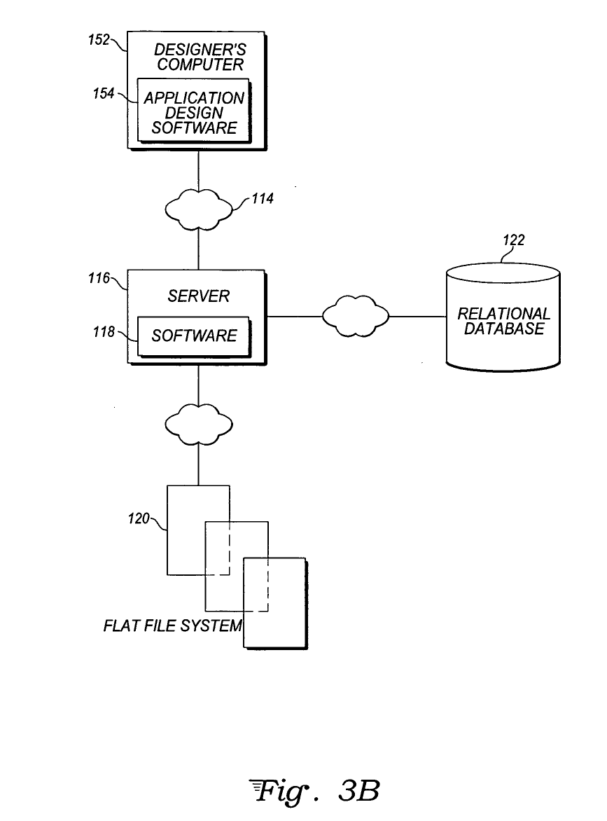

The automation of business processes and their activities may be accomplished using software in a network setting. In FIG. 3a, a server 116, in addition to running software for handling server and network operations, is running software 118 for automating business processes and activities. As is well-known, software is a computer-readable storage medium (including compact disc, computer diskette, computer memory, etc.) with code or instructions which, when read and executed by the computer, causes the computer to perform a process or task. (In this embodiment, the process and activity automation software is accessed through a Web interface and the activity forms are presented to users as Web pages. In other embodiments, the software and/or the forms is stored on individual computers and is not accessed via the Web.). A computer 110 is connected to the server 116 via a network 114, such as the Internet, LAN, etc. The computer 110 is able to access the process/activity software 118 on the server 116 via a web browser 112, such as Microsoft INTERNET EXPLORER or NETSCAPE NAVIGATOR. (In one embodiment, the process/activity software 118 is compatible with J2EE servers. In some embodiments, an application server (not pictured) is required to deploy the software 118.) The server 116 is also connected via a network 114 to process-related data sources such as a relational database 122 and a flat file system 120; these process-related data sources may be accessed by the software 118. In other embodiments, the computer 110 may be connected directly to any of the server 116 or process-related data sources 122, 120. In other embodiments, other process-related data sources, such as web services, enterprise applications, etc., may be accessible to the server 116. The process-related data sources may also be directly connected to or stored at the server 116.

Referring to FIG. 3b, a process flow, similar to that shown in FIG. 1, may be designed using a separate application. A designer, using a computer 152 running application design software 154, is connected via a network to a server 116 running process/activity software 118. The server is also connected via a network to process-related data sources, such as a flat file system 120 and a relational database 122. In other embodiments, the designer's computer 152 is not connected to the server. In still other embodiments, features of the application design software 154 are incorporated into the process/activity software 118 so that stand-alone design software is not required. In yet other embodiments, the application design software 154 is connected via a network to process-related data sources, such as a flat-file system 120 and a relational database 122.

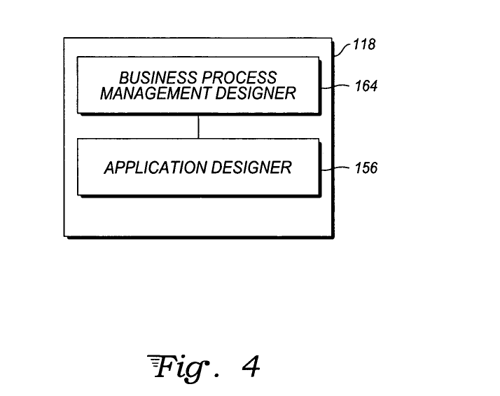

With reference to FIG. 4, in one embodiment, the process/activity software 118 may have multiple modules or engines. The Business Process Management (“BPM”) Designer 164 models a business process, deploys that model, and manages the automated aspects of the business process, an Application Designer 156 designs forms. Other embodiments, may feature other modules or engines to perform or manage other tasks which include, but are not limited to, Web services for deploying the process/activity software 118, creating reports, and accessing external elements, such as process-related sources, third-party applications, etc. A form completed using the application design software 154 is incorporated in and deployed by the process/activity software 118. In other embodiments, any or all of these modules or engines may comprise separate applications or may be combined in one or more applications. Other embodiments may feature other modules or engines.

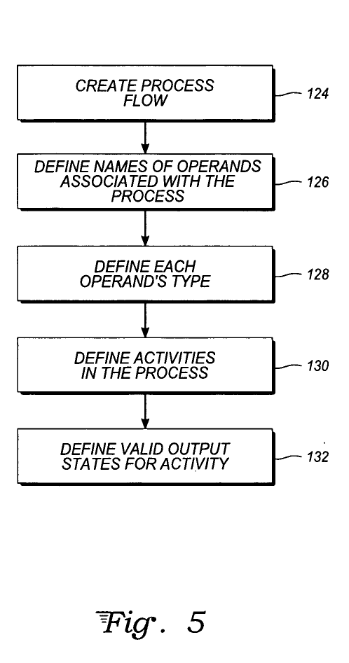

In FIG. 5, automating a business process requires creating a process flow (block 124), similar to that shown in FIG. 1. In one embodiment, using the BPM, discussed above, the process flow, or a diagram of the process, may be created using point-and-click images associated with fill-in-the blank dialog boxes. (Other embodiments may employ other approaches to modeling the process flow, such as using Universal Modeling Language (UML). Business process modeling packages are known in the art.) An XML document is created from this process flow. This XML document is subsequently used by the application server (discussed above) to execute the business process. (Other approaches may be employed by other embodiments.) When creating the process flow, the business logic, actors, operands (data objects with typed name/value pairs), and possible status codes of activities or subactivities within the process (approved, canceled, completed, etc.) of the process are identified. (For instance, by using an application program interface (“API”).) Referring again to FIG. 5, the name of each operand associated with the process needs to be defined (block 126). Each operand's type also needs to be defined (block 128). The following table indicates exemplary control types of each type of operand:

| | Generated | Generated | |
|---|---|---|---|
| Operand type | control | data type | Generated properties |
| Checkbox | Checkbox | String | |
| Currency | Text field | Amount | Display justify: right |
| Database object | Text field | String | |
| Date | Text field | Date | |
| E-mail | Text field | String | |
| File | File chooser | Binary | |
| Long text | Text area | Text | |
| Number | Text field | Amount | Display justify: right |
| PDF form | Inline frame | n/a | Source property set |
| | | | to URL which downloads |
| | | | the form |
| Pick list | Dropdown list | String | |
| Short text | Text field | String | |
| Title | Text field | String | |
| URL | Link | n/a | |
| User | Text field | String | |

Each activity in the process also needs to be defined (block 130), as well as the valid output states for the activity (block 132).

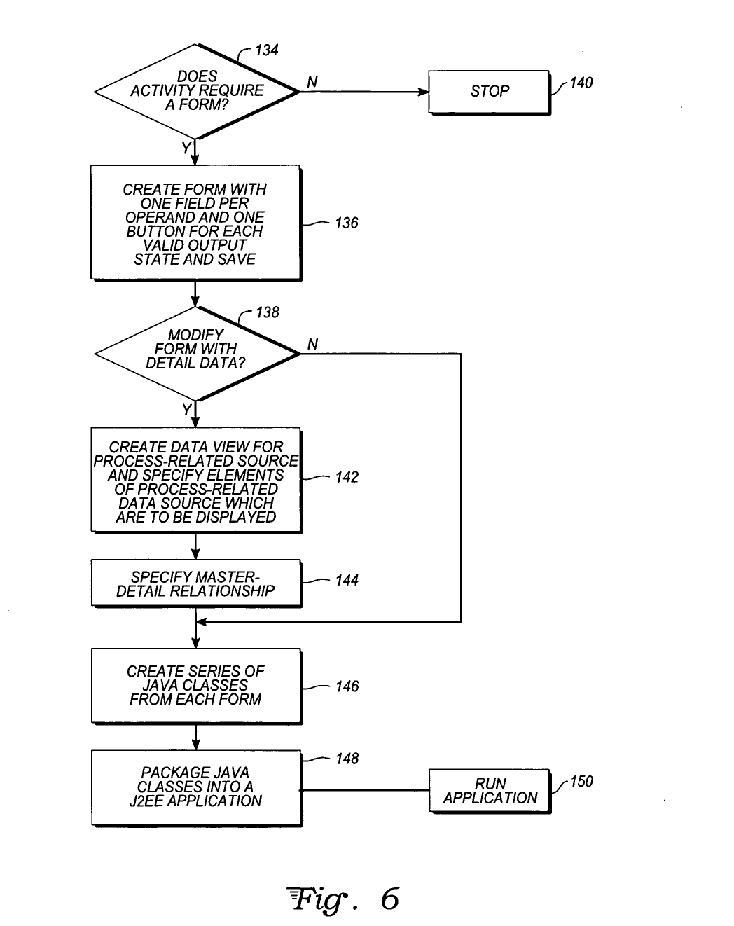

Once the process flow is defined, the business process workflow user interfaces, or activity forms, for each activity may be designed using the Application Designer. (In one embodiment, this may be done by using a form wizard designed to lead the designer through the steps required to create an activity form.) With reference to FIG. 6, a determination of whether an activity within a process requires a form is made (block 134). If no form is required (block 134), there obviously is no need to create a form (block 140). However, if a form is required (block 134), a form is created with one field per operand (as specified by the designer; the list of operands is initialized based on the operands defined in the process flow) and zero or more buttons for each valid output state (the list of buttons is initialized from the transitions out of the activity defined in the process flow diagram) (block 136); the form may then be saved.

In one embodiment, the form is stored as two files: one containing jBiz source code and the other a Java Server Page (“JSP”) file. Application-specific logic may be added to the jBiz source file. The HTML elements in the JSP file may contain specific properties in addition to the standard HTML properties. For example, the HTML element for the form contains the name of the process and the name of the activity, the HTML elements for the fields contain the name of the operand and the name of the state. In other words, metadata is stored as extended HTML files. The form may be stored in other formats in other embodiments.

When the activity form has been associated with an activity and one or more fields have been added to the form along with any required buttons corresponding to valid output states (block 136), the form may be modified with detail data, i.e., process-related data from a variety of relational and non-relational sources (block 138). (In one embodiment, this may be done by using a wizard designed to lead the designer through the steps of adding detail data to the form.) An activity form may include data from any number of data sources. The data from each source appears on the form as a data view; a form may have one or more data views formed in any hierarchical relationship within the form. For instance, a form may display customer information from an ORACLE database, invoice numbers from an SQL Server database, and open customer inquiries from a web service or SAP transaction.

If no modification is needed (block 138), the form is compiled as discussed in greater detail below (blocks 146 et seq.). However, if modification is desired (block 138), the detail data must be added to the form. A data view is created for the process-related data source and the elements the designer wishes to display from that process-related data source are identified (for instance, a table in a database may be specified along with the fields to be displayed (which may be obtained, for instance, from the name of a column in a table); the source programming script may also be used to access operands and fields) (block 142). A master/detail relationship between the data view and either the process data or another data view contained in the form is then specified; for example, a master/detail relationship may be specified where the operand serves as a master key and the detail data is added accordingly (block 144). (As one example, if the process data operand is a ticket number, and the process-related data to be added to the form in a data view is information about the customer associated with the particular ticket number, the designer would create a data view where the process data operand is the master key (the actual form is the master in this master/detail relationship) and the process-related data about the customer as the detail records. Using this master/detail relationship, the designer can specify that the data view should be populated with customer records for the customer associated with a particular ticket number.) In some embodiments, a wizard may be used to add the detail data; this wizard would prompt the developer to identify the data source and the elements of the data source to be displayed and to specify the fields which should be added to the form. Data views may be assembled in different orders than the one specified above; however, no matter the order specified, the data source to be used, the elements of the data source to be displayed, and the master/detail relationship between either the process data or another data view on the form must be specified.

A series of Java classes is then created from each form (block 146). In one embodiment, this step is triggered when the user issues a command to “make” the form. The general capabilities provided by these Java classes are: database access; management of application events; transaction management; JavaBean access; and security management. Essentially, one class is created for each HTML element in the JSP file. Constructors for the classes take arguments corresponding to the properties in the HTML element, i.e., the operand name. The classes are generated by parsing the JSP file and then building another metadata file. Each of these Java classes is packaged into a J2EE application, discussed in greater detail below (block 148). The application with the completed, compiled form may then be run (block 150). Using the approach specified above, no manual custom coding or mapping of the process or process-related data, for instance, designing and creating generic data structures populated by required data and then mapping the data in the generic data structure to the format required by the service package, is required for integrating different data sources within the form.

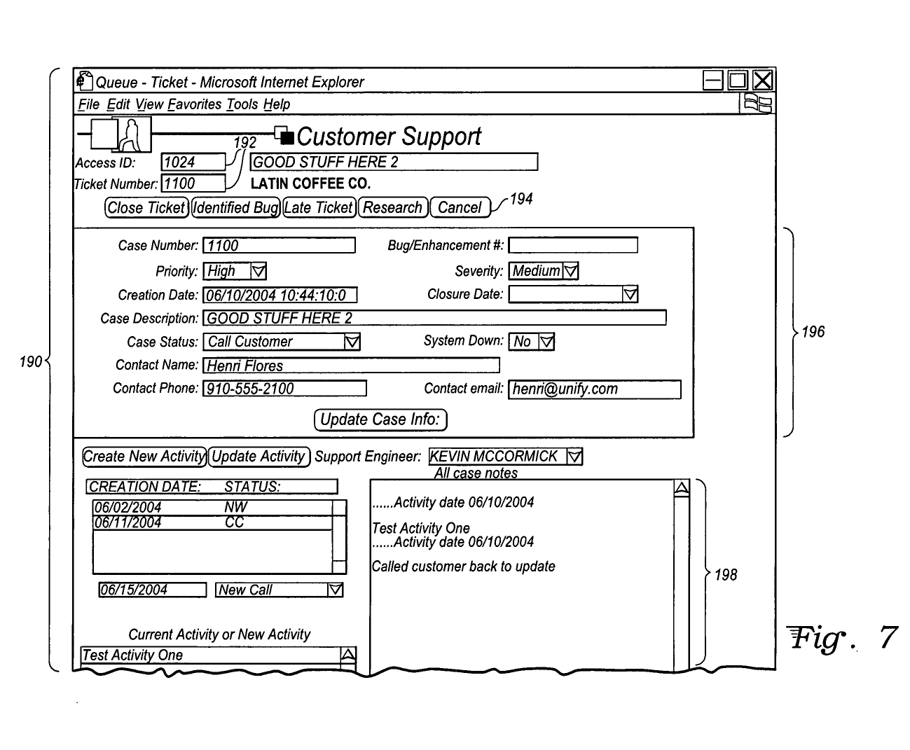

An exemplary activity form 190 is shown in FIG. 7. This form 190 is used for customer support for software. The process data 192 identifies the AccessID of the customer and the ticket number. The form also provides buttons 194 for workflow actions (corresponding to the valid output states of the activity) such as “Close ticket,” “Identified bug,” “Late ticket,” etc. Process-related data 196, 198 is also included in the form. For instance, process-related data 196, from a relational database, gives details about the customer's reported problem, giving contact information about the customer, when the problem was reported, what bug was detected or enhancement added, data of closure, etc. Process-related data 198, from web services, offers information about services provided to the customer.

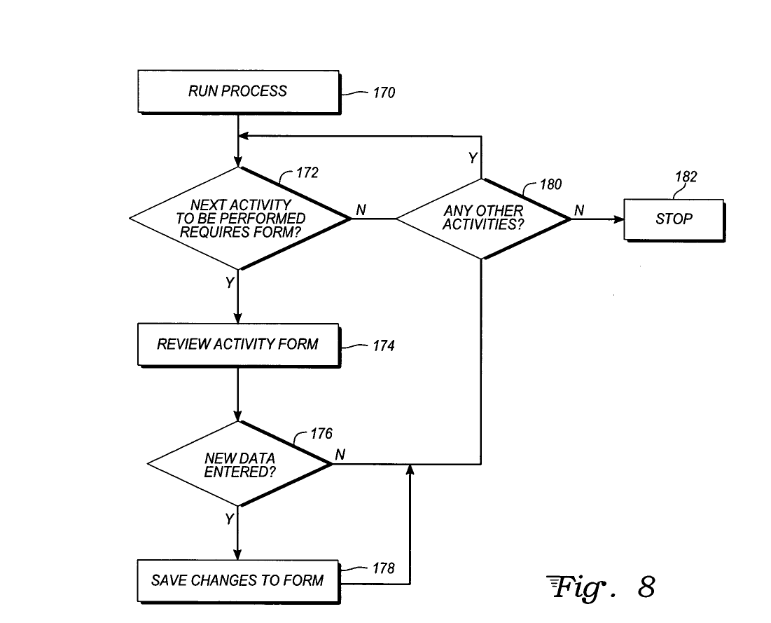

In FIG. 8, once the activity forms have been designed and deployed, the automated business process may be implemented (block 170) using the activity forms. If the next activity within the process requires a form (block 172), the activity form is presented to the appropriate user who can review it (block 174) and modify the data on the form as required (block 176). If new data is entered (block 176), these changes to the form are saved (block 178). If no new data is entered (block 176), or if the changes have been saved (block 178), or if the next activity in the business process did not require a form (block 172), a determination is made as to whether any other activities need to be performed in order to complete the process (block 180). If more activities remain (block 180), a determination is made as to whether a form is to be used (block 172) and the activity form procedure continues as described above in blocks 172 et seq. However, if no other activities remain in the process (block 180), the business process is finished (block 182).

In one embodiment, the unmodified form may be modified in the software's Application Designer, discussed above. The JSP file is parsed, the properties of each element saved, and the JSP page displayed. To change the properties of a field, label, etc., the designer clicks on that field, label, etc., at which point the properties of the field, label, etc. are displayed. These properties may then be changed. If one or more properties is changed, and the modified form is saved, the Application Designer writes out the modified JSP file.

The designed application, including any developed forms, is compiled by the Application Designer. In one embodiment, the compiler processes Java source and generates new Java source corresponding to the application specifications, then compiles the source. The various application components are then packaged into their respective War and Jar files, ultimately packaging the entire application as a J2EE Ear file. (The Ear file along with application-server specific deployment descriptors and files are deployed to a target J2EE server. The Application Designer launches a browser window and initiates the application.) In one embodiment, this compilation process generates a standard J2EE application that performs database queries, interacts with the BPM Engine, populates the forms, and incorporates and saves all updates performed on underlying data, whether it is process data or process-related data.

In one embodiment, the form is a JSP page with some auxiliary files containing metadata. Most of the metadata, including all of the information collected by wizards used to design the form (process name, operand name, etc.) is stored directly in the JSP page.

When the application is compiled, the Application Designer reads the metadata and generates Java classes that display the form, performs database queries, etc. In one embodiment, these classes make use of a series of foundation classes which provide generic, low-level functionality for performing database queries, etc. These foundation classes may be included with the process/activity software. As noted above, the capabilities provided by these Java classes are: database access; management of application events; transaction management; JavaBean access; and security management.

In one embodiment, programming may be done using Java and the J2EE platform. The applications are multi-tier, J2EE-compliant web applications. Server-side, event-triggered Java code associated with a form is encapsulated within an Enterprise JavaBean (“EJB”) session bean at runtime. In one embodiment, the Application Designer automatically generates all necessary EJB session bean code for the designer. This code may be accessed directly through the Application Designer. Other languages and platforms may be used in other embodiments.

In the foregoing description, the present invention has been described with reference to specific embodiments. It will, however, be evident to a skilled artisan that various changes and modifications can be made to these embodiments without departing from the broader spirit and scope of the present invention as set forth in the appended claims. The specification and drawings are therefore to be regarded in an illustrative rather than a restrictive sense.

1. A method for creating an activity form featuring process data and process-related data, the method comprising:
a) identifying an activity within a process requiring a form;
b) creating an activity form with least one field associated with an operand representing process data;
c) modifying the activity form by adding at least one field from the process-related data source to the activity form; and
d) specifying a relationship between the at least one operand and at least one process-related data source.

2. The method of claim 1 further comprising creating series of JAVA classes from each activity form.

3. The method of claim 2 further comprising packaging the JAVA classes into a J2EE application.

4. The method of claim 1 further comprising customizing an appearance of the activity form.

5. The method of claim 1 wherein no manual coding of either the process data or the process-related data source is required to create the activity form.

6. The method of claim 1 further comprising compiling the activity form to run as part of an application.

7. The method of claim 1 further comprising adding to the activity form at least one button indicating a decision to be made by an end user of the activity form.

8. The method of claim 1 wherein the process-related data source is a relational data source.

9. The method of claim 1 wherein the process-related data source is a non-relational data source.

10. The method of claim 1 further comprising entering data in the activity form.

11. The method of claim 10 further comprising saving data entered in the activity form.

12. The method of claim 1 further comprising displaying data from a plurality of process-related data sources in the activity form.

13. The method of claim 1 further comprising presenting the activity form to an end user via a web interface.

14. A computer-readable storage medium storing instructions that, when executed by a computer, cause the computer to perform a method for creating an activity form featuring process data and process-related data, the method comprising:
a) identifying an activity within a process requiring a form;
b) creating an activity form with least one field associated with an operand representing process data;
c) modifying the activity form by adding at least one field from the process-related data source to the activity form; and
d) specifying a relationship between at the least one operand and at least one process-related data source.

15. The computer-readable storage medium of claim 14 wherein the method further comprises creating series of JAVA classes from each activity form.

16. The computer-readable storage medium of claim 14 wherein the method further comprises packaging the JAVA classes into a J2EE application.

17. The computer-readable storage medium of claim 14 wherein the method further comprises customizing an appearance of the activity form.

18. The computer-readable storage medium of claim 14 wherein no manual coding of either the process data or the process-related data source is required to integrate the process and process-related data into the activity form.

19. The computer-readable storage medium of claim 14 wherein the method further comprises compiling the activity form to run as part of an application.

20. The computer-readable storage medium of claim 14 wherein the method further comprises adding to the activity form at least one button indicating a decision to be made by an end user of the activity form.

21. The computer-readable storage medium of claim 14 wherein the process-related data source is a relational data source.

22. The computer-readable storage medium of claim 14 wherein the process-related data source is a non-relational data source.

23. The computer-readable storage medium of claim 14 wherein the method further comprises entering data in the activity form.

24. The computer-readable storage medium of claim 14 wherein the method further comprises saving data entered in the activity form.

25. The computer-readable storage medium of claim 14 wherein the method further comprises displaying data from a plurality of process-related data sources in the activity form.

26. A method for automating at least part of a business process by using an activity form comprising:
a) identifying an activity within a business process flow where a form may be used;
b) creating an activity form having at least one field associated with an operand representing process data and at least one field of process-related data, wherein a relationship between the operand and a source of the process-related data is indicated during creation of the activity form, and a button indicating a decision to be made by an end user of the activity form;
c) presenting the activity form to an end user when requested by the end user; and
d) saving any changes made by the end user to any data in the activity form.

27. The method of claim 26 further comprising creating series of JAVA classes from each activity form.

28. The method of claim 27 further comprising packaging the JAVA classes into a J2EE application.

29. The method of claim 26 further comprising customizing an appearance of the activity form.

30. The method of claim 26 wherein no manual coding of either the process data or the process-related data source is required to create the activity form.

31. The method of claim 26 further comprising compiling the activity form to run as part of an application.

32. The method of claim 26 wherein the process-related data source is a relational data source.

33. The method of claim 26 wherein the process-related data source is a non-relational data source.

34. The method of claim 26 wherein the activity form is presented to the user via a web interface.

35. The method of claim 26 further comprising displaying data from a plurality of process-related data sources in the activity form.
